(19) United States
(12) Patent Application Publication
(10) Pub. No.: US 2008/0022291 A1
(43) Pub. Date: Jan. 24, 2008

(54) Device And Method For Computer Display Synthesis

(76) Inventor: Tong Shao, Jiangsu Province (CN)

Correspondence Address: Raymond Yat Chan, 108 North Ynez Avenue, Suite 128, Monterey Park, CA, 91754, US

(21) Appl. No.: 11/792,153

(22) PCT Filed: Nov. 28, 2005
(86) PCT No.: PCT/CN05/02036

§ 371 Date: May 31, 2007

(30) Foreign Application Priority Data
Dec. 1, 2004 (CN) 200410065395.X

(51) Int. Cl. G06F 9/48

(52) U.S. Cl. 719/321

(57) ABSTRACT

A device and method for computer display synthesis are provided. The device collects the display output information of each operation system; according to the content of each operation system display windows register, the device synthesizes the display information of each operation system to the corresponding windows for displaying, outputs the information to a screen, determines the position of the mouse on the screen, and sends the information to display synthesis control device; according to the present position of the mouse and the content of each operation system windows register, determines the operation system locates in which the mouse, connects the mouse and the present operation system, or clicks the mouse to confirm, and then connects with it.

### BACKGROUND OF THE PRESENT INVENTION

1. Field of Invention

The present invention represents a device and method for switching and displaying between multiple separated computing devices or multiple separated operation systems (or processes), and more particularly to a device and method for switching and displaying between multiple computing devices in a secure, convenient and fast manner.

2. Description of Related Arts

In the field of computer security, internal network (e.g. in the office or confidential network) and external network (e.g. internet) are physically separated based on security considerations. A method for solving this problem is to use two computers to connect to internal and external networks respectively. Obviously, this method needs two monitors, keyboards, and computer mice. In view of existing techniques, a sharing device (KVM) can solve this problem. It can also be solved by an improved technique (referring to Chinese Patent Application ZL02138561.5). In addition, the problem can be solved by using time-sharing or real time switching computer (referring to Chinese Patent Applications ZL01117401.3, ZL01115545.8). However, one computer or one operation system totally occupies the display monitor in all these methods mentioned above and it cannot be a multiple display system, such as Microsoft Windows, to achieve a user-friendly display manner by applying one window to one operation system. When computer users use multiple computers or time-sharing computers, multiple windows to show each computer's condition is desired and accorded with the uses' habits. The goal of “one computer divided to two to satisfy security requirement; two computers combined to achieve a user-friendly interface.”

It is a trend to achieve a secure separation process in the field of computer security. Thus, Intel proposed a “Lagrande” (LT) technique (Intel 2003 IDF) and a “Vanderpool” (VT) technique to virtually achieve simultaneous computation in multiple operation systems (Intel 2003 IDF). LT security technique is to introduce a security domain management device to separate security processes from general processes and achieve the goal of security computation. VT technique is actually a virtual operation system in a computer (also called a domain management device), and taking the general operation system as process of the virtual operation system to achieve simultaneous computation in multiple operation systems (IBM patented technology).

However, although multiple-window display in the multiple operation systems can be achieved through control of domain management device, the efficiency of the display and the computer is significantly decreased. It is the major reason why current VT technique is not yet mature. If each operation system can individually use the same display memory, the security is not guaranteed in an operation system, a process to read in the operation system or a process to display messages. Meanwhile, because each operation system is not aware of the conditions of other operation systems, the situation of chaotic display would probably occur. In order to assure that displaying messages in multiple processes is secure, Intel's LT technology adopted a method of encryption in the process of displaying messages to ensure security.

Thus, in order to ensure security, these operation systems have to be separated and can not exchange information. If information exchange can be totally controlled, being unable to read and write display messages to other operation systems must be guaranteed. In addition, showing display conditions of multiple operation systems through multiple windows is preferred.

FIG. 1 is the working principle of computer display (the figure is from page 8 of “Principles and Applications of IBM PC” published by Nan-King University, 1990), wherein the computer comprises a main body 1, a graphic card or a display system 2, such as an AGP graphic card, and a monitor 3. To achieve the goal of display, the main body 1 writes data into the memory of graphic card 2 and the messages transmitted to monitor is so called scanned messages.

In existing technologies, there is a special display overlapping device (scanned overlapping), namely a switch between a projection apparatus and KVM. FIG. 2 is the working principle of the projection apparatus. The major function of the projection apparatus is to project the output messages from computer 1 through the projection apparatus 2. However, to adjust the working condition of the projection apparatus, such as brightness, direction and contrast, the projection apparatus comprises a scanned display overlapping device 21 and a device 22 to control and adjust the messages sent out from the projection apparatus. According to the messages adjusted by the device 22, the scanned display overlapping device 21 adds such messages to the output messages of computer 1, and then sent out from projection 23.

FIG. 3 is the working principle of KVM switch. The function of KVM switch is to connect between computer 1 and computer 2, keyboard 41, mouse 43 and monitor 42, wherein more than two computers can be operated by one set of keyboard, mouse and monitor. Another graphical KVM switching method is through special function keys on keyboard 41 to transmit the desired messages to KVM controller-switch-message output 33. Such device generates all signal messages from the computers connected to KVM, and the signal messages are added to the messages of the screen which is currently used through display synthesis device 32, and output from monitor 42. Thereafter, users can choose the computers through keyboards based on the messages displayed on the screen. According to users' choices, KVM control-switch-message output 33 control multiple-way electronic switch 31, switch and keyboard 41, mouse 43 and monitor 42.

However, all these existing technologies are based on the graphics outputted by computers. Overlapped messages are located in fixed arithmetical localities where the messages are finally displayed, and it is unnecessary to add multiple windows to display messages of multiple computers. In addition, existing overlapping technologies are all scanned overlapping, meaning using the scanned messages in overlapped windows while scanning the scanned messages outputted from the computer to the overlapped windows.

### SUMMARY OF THE PRESENT INVENTION

A main object of present invention is to provide a method and device to solve the problem of simultaneous display in multiple separated operation systems based on the background technology stated previously. Namely, using a mouse (or keyboard) accords with display devices to achieve the connection between the mouse or keyboard and corresponding operation systems and to solve the problem of compatibility between multiple operation systems and softwares.

In a preferred aspect of the present invention, a computer display synthesis device comprises a connecting device adapted for communicatively connecting display outputs of said computer devices each of which has an operating window; a memory adapted for storing arithmetical localities of output signals of said computer devices; an outputting device for synthetically outputting said operating windows to the display screen; an input selection device and a display synthesis control device.

The display synthesis control device, working through the connecting device, receives display messages provided by each computer display device. According to the arithmetical localities of output signals of the computer devices stored by the memory, the display synthesis control device generates displays in multiple windows regarding multiple computations, and outputs through the display and control synthesis device. When certain computation is ascertained by the input selection device, the display synthesis control device connects the input selection device to corresponding computation.

In the present invention, the multiple connected display devices can be a monitor. Also, the input selection device is a screen locator and when the screen locator is within a computer display window, the screen locator is connected with corresponding computer through the display synthesis control device. The screen locator comprises a device selected from the group consisting of a mouse, an electronic pen and a touch screen. Preferably, one of the windows is a background window, meaning that the window occupies the entire screen but it is located at the very bottom of all other windows.

In addition, the input selection device can be a keyboard which can be connected to corresponding computation through display synthesis control device, and final display is generated by overlapping corresponding selected display to the screen. Preferably, one of the windows is a background window, meaning that the window occupies the entire screen but it is located at the very bottom of all other windows. It is noted that multiple computer display devices can either be computers separated from each other, or multiple operation systems in one computer.

Another purpose of the present invention is to provide a method to achieve computer display synthesis. The method comprises three steps: First, the computer display synthesis device ascertains the location of the mouse on the screen. Second, the computer display synthesis device ascertains the operation system in which the mouse is located according to the current location of the mouse and the content of each operation system window register. Third, the mouse and the current operation system are connected through the computer display synthesis device. Generally speaking, in step three, the connection between the mouse and current operation system can be achieved by clicking the mouse. Furthermore, in step three, the user's identification should be confirmed to precede the connection between the mouse and current operation system. Preferably, the confirmation method in step three can be that clicking at least once on the left key of the mouse. Meanwhile, the background operation system can be changed or unchanged by clicking the mouse.

Preferably, the layers of overlapped windows of operation systems can be changed by clicking the left key of the mouse once. While clicking twice, the corresponding operation system is changed to background operation system and the background operation system is changed to corresponding display window.

To be more completely, the steps before the first step comprise: collecting the display output messages of each operation system; according to the content of each operation system display windows register, synthesizing the display messages of each operation system and displaying them on corresponding windows; and outputting the messages to the screen.

It is obvious that the steps in the methods stated above can be arranged to some meaningful combinations.

### BRIEF DESCRIPTION OF THE DRAWINGS

FIG. 1 is a schematic representation of the working principle of a computer display.

FIG. 2 is a schematic representation of a projection apparatus.

FIG. 3 is a schematic representation of KVM.

FIG. 4 is a schematic representation of embodiment 1 in the present invention.

FIG. 5 is a schematic representation of embodiment 2 in the present invention.

FIG. 6 is a schematic representation of embodiment 3 in the present invention.

FIG. 7 is a schematic representation of embodiment 4 in the present invention.

FIG. 8 is a schematic representation of existing computer structures.

FIG. 9 is a schematic representation of embodiment 5 in the present invention.

FIG. 10 is a schematic representation of embodiment 6 in the present invention.

FIG. 11 is a schematic representation of embodiment 7 in the present invention.

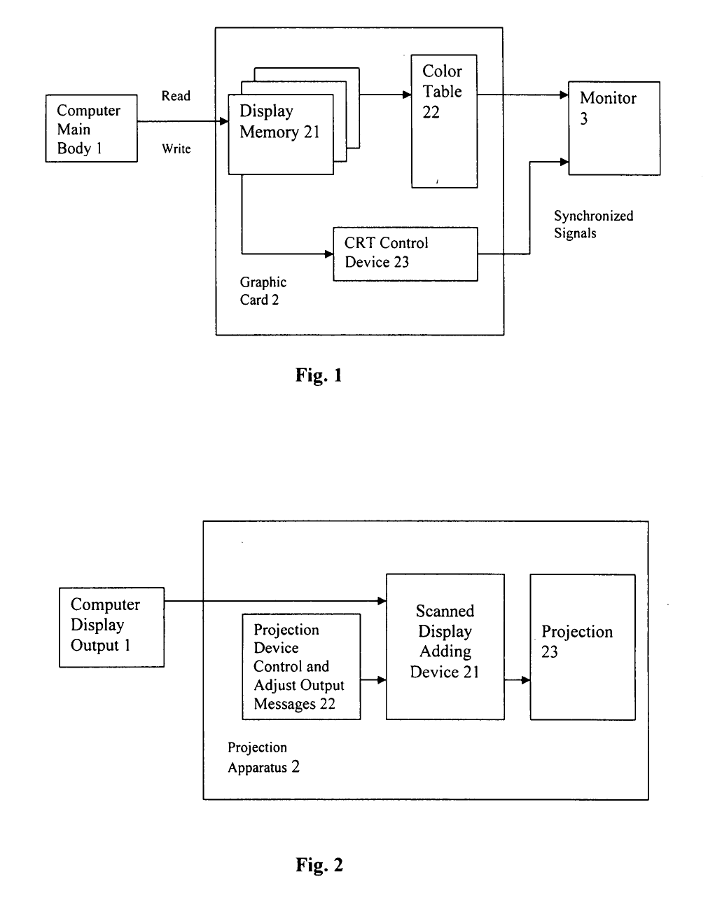

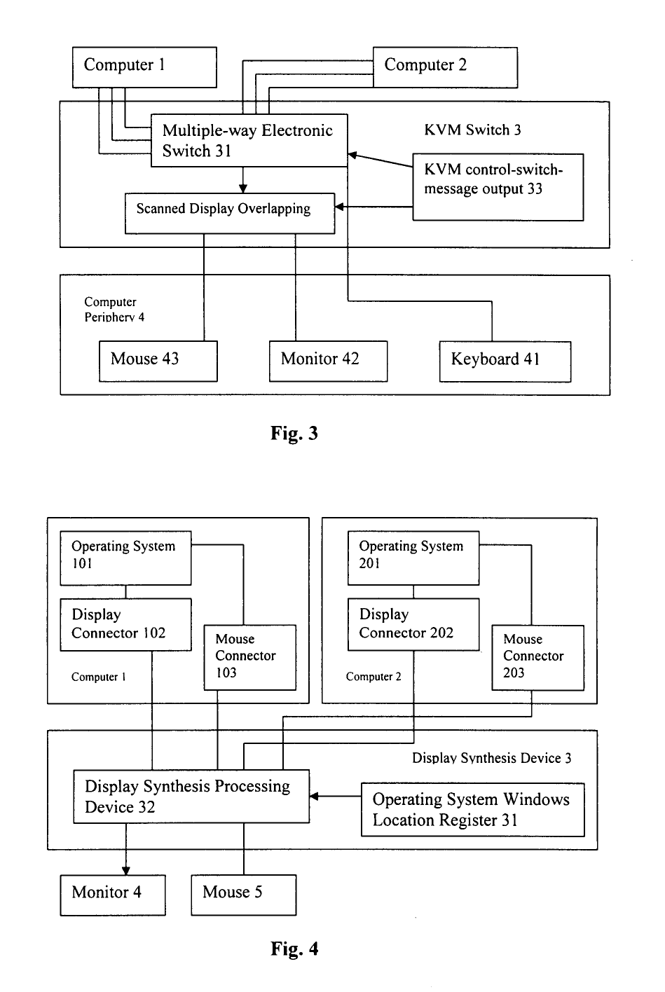

### DETAILED DESCRIPTION OF THE PREFERRED EMBODIMENT

### Embodiment 1

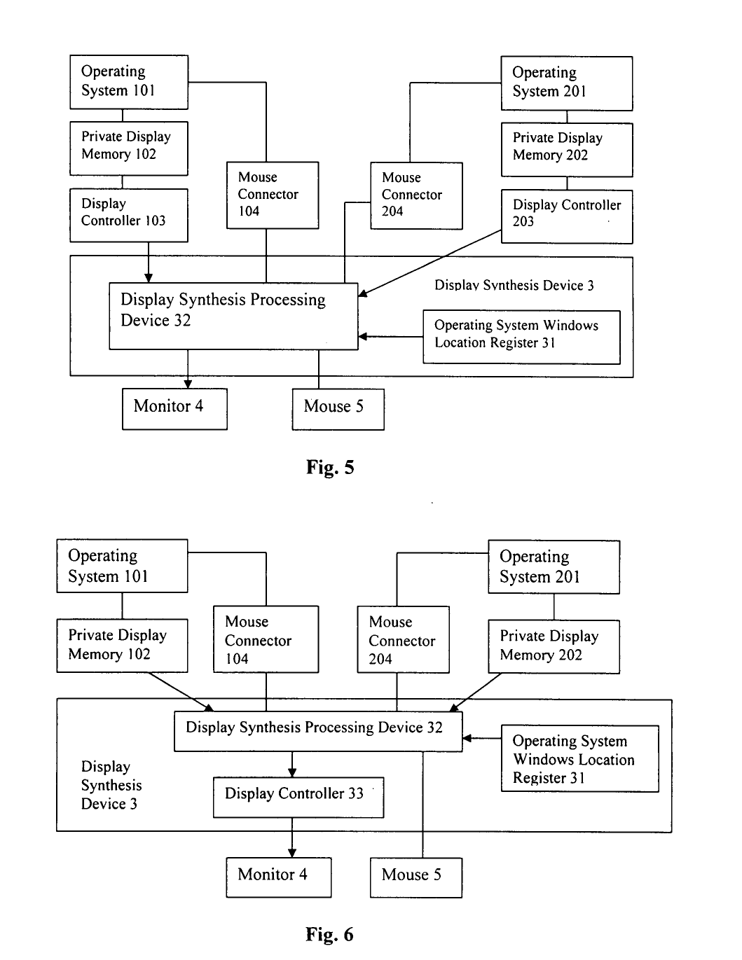

As illustrated in FIG. 4, a display connector 102 and a mouse connector 103 of a computer 1 are connected to a display synthesis processing device 32, while a display connector 202 and a mouse connector 203 of a computer 2 are connected to the same display synthesis processing device 32. In a display synthesis device 3, an operation system windows location register 31, a monitor 4, and a mouse 5 are connected to the display synthesis processing device 32. An operation system 101 is connected to the display connector 102 and the mouse connector 103, while an operation system 201 is connected to the display connector 202 and a mouse connector 203. It is worth mentioning that each computer has an operating window which can represent an ongoing process.

The outputs of the operation system 101 are sent to the display synthesis device 3 through scanned messages displayed in the display connector 102, wherein display synthesis processing device 32 sends the scanned messages outputted from computer 1 to the corresponding arithmetical locality in monitor 4, based on the information of the operation system 101 stored in operation system window location register 31. The outputs of operation system 201 are sent to the display synthesis device 3 through scanned messages displayed in the displayed connector 202, wherein display synthesis processing device 32 sends the scanned message outputted from computer 2 to the corresponding arithmetical locality in monitor 4, based on the information of the operation system 201 stored in operation system windows location register 31. Based on different locations of mouse 5 in the monitor, the display synthesis processing device 32 connects mouse 5 to corresponding locations. For example, if the current location of mouse 5 is in the operating window of operation system 101, the display synthesis processing device 32 connects the mouse to mouse connector 103 in computer 1. If the current location of mouse 5 is in the operating window of operation system 201, the display synthesis processing device 32 connects the mouse to mouse connector 203 in computer 2. Connection between the mouse and computer can be made by hardware. Connection can also be made through the messages sent by the mouse to display synthesis processing device which transmits the messages. If the messages are transmittable, the connection is successful. If not, then there is no connection.

Obviously, displaying two operating windows of two computers can be successfully outputted to one monitor through the embodiment. However, each computer has its own monitor and the messages of two computers can not be completely shown on one single monitor. To solve this problem, the display synthesis processing device can proportionally reduce the sizes of the operating windows based on the arithmetical locality of the size stored in the memory and simultaneously outputs two displays in one monitor. This method can achieve the effect of displaying two computer operating windows but not overlapping of each other. This method can also achieve the effect of displaying multiple computer outputs. Alternatively, one of the computers can be designed as a background computer and the operating window thereof is set as a background window on the display screen, while the other one is a general computer whose display messages are added to the display of the background computer. When the mouse is in the area of the general computer, it connects with the general computer. When the mouse is in the area not belonged to the general computer, it connects with the background computer. As long as the background computer is assigned, this method can also be used in multiple computer displays. It is convenient for the user when the messages can be transmitted through the mouse or the keyboard to the display synthesis processing device to change the background computer to computer 2. Other message transmitting devices can also be applied to tell the display synthesis processing device to change the size of the window in the background computer and the general computer.

The difference between embodiment 1 and existing techniques is that the mouse is not associated with the content of overlapping display, meaning there is no communication between the mouse and the content of overlapping display. In addition, putting two computer main boards into one computer and incorporating display synthesis devices thereon can also achieve this kind of display.

In first embodiment, there are two complete computers. One computer used to compute two independent operation systems is preferred in Intel's VT technology, while in Intel's LT technology, an operation system and a separated secure process is preferred. Thus, Intel's VT and LT technologies are in fact to achieve a management domain and either the operation system or security process is one process therein.

In the inventor's Chinese patent applications (referring to Chinese Patent Application ZL01117401.3, ZL 01115545.8), a real time switching computer is a computer to accomplish the goal of time sharing in a plurality of operation systems. If the operation system's speed is fast enough, one computer can simultaneously compute two independent operation systems. A secure switching process in the Chinese patents is, to some extent, the secure domain management device under current structure of computers. However, it is difficult to achieve the goal of displaying two operation systems in one computer. If all the displays are managed by the secure domain management device, the efficiency of display and the computer is decreasing. If the display is not managed by the secure domain management device, it is difficult to guarantee that the messages between two operation systems are exchanged authorizedly. This is why Intel's VT technology took years to be marketable. Inspired by embodiment 1, embodiment 2 is thus followed.

### Embodiment 2

In this embodiment, the operation system 101 scans and outputs display messages to the display synthesis processing device 32 through a private display memory 102 and a display control device 103. The operation system 201 scans and outputs display messages to the display synthesis processing device 32 through a private display memory 202 and a display control device 203. In the display synthesis device 3, the operation system window location memory 31, monitor 4 and mouse 5 are connected with the display synthesis processing device 32, as shown in FIG. 5.

Outputs of the operation system 101 are sent to the display synthesis device 3 through the private display memory 102 and display control device 103 in which the display synthesis processing device 32 sends scanned messages of display outputs in the operation system 101 to corresponding arithmetical localities in monitor 4, based on the locality of operation system 101 in operation system windows location memory 31. Outputs of operation system 201 are sent to the display synthesis device 3 through the private display memory 202 and display control device 203 in which the display synthesis processing device 32 sends scanned messages of display outputs in operation system 201 to corresponding arithmetical localities in monitor 4, based on the locality of operation system 201 in operation system window location memory 31. According to different locations, for example, if the current location of mouse 5 is in the operating window of operation system 101, the display synthesis processing device 32 connects the mouse to mouse connector 103 in computer 1. If the current location of mouse 5 is in the operating window of operation system 201, the display synthesis processing device 32 connects the mouse to mouse connector 203 in computer 2. Connection can also be made through the messages sent by the mouse to display synthesis processing device which transmit the messages. If the messages are transmittable, the connection is successful. If not, then there is no connection.

Difference between current embodiment from embodiment 1 is that current embodiment uses two operation systems instead of two computers. Also, video memory in these two operation systems is separated from each other to assure security. Method of two operation systems used by one computer can be seen in Chinese Patent Application ZL01117401.3 and ZL01115545.8.

Obviously, outputs of the display of two operation systems to one monitor through the current embodiment are achievable. However, display of each operating window presumably uses a complete screen. If only one screen is presented, it is apparent that the messages can not be shown completely.

To solve this problem, the display synthesis processing device can proportionally reduce the sizes of the display based on the locality of the size stored in the register and simultaneously outputs two displays in one monitor. This method can achieve the effect of displaying two computer outputs but not overlapping with each other. This method can also achieve the effect of displaying outputs of multiple computers. Alternatively, one of the computers can be designed as a background computer and the operating window thereof is set as a background window on the display screen, while the other one is a general computer whose display messages are added to the display of the background computer. When the mouse is in the area of the general computer, it connects with the general computer. When the mouse is in the area not belonged to the general computer, it connects with the background computer. As long as the background computer is assigned, this method can also be used in multiple computer displays. It is obvious that the messages can be inputted by the mouse or other message input devices to tell display synthesis processing device to change the background-operation-system to make it convenient for the users. It is obvious that the messages can be inputted by the mouse or other message input devices to tell display synthesis processing device to change the sizes of the windows of background and general operation systems to make it convenient for the users.

For time sharing separated computers, the background operation system can be treated as a pre-operation system; the general operation system can be treated as a hung operation system; and the switch of the background operation system is the switch of the operation system.

### Embodiment 3

As can be seen in FIG. 6, display messages of the operation system 101 are stored in the private display memory 102 and display messages of the operation system 201 are stored in the private display memory 202. Private display memory 102 and 202 are respectively connected to the display synthesis processing device 32. The operation system windows location register 31 is connected to the display synthesis processing device 32, the monitor 4 is connected to a control device 33, and the mouse 5 is connected to the display synthesis processing device 32.

Based on the information of the operation system 101 in the operation system windows location register 31, the display synthesis processing device 32 in the display synthesis device 3 transmits the display message of the private display memory 102 of the operation system 101 to the corresponding arithmetical locality in the monitor 4 through the display control device 33. In the same manner, based on the information of the operation system 201 in the operation system windows location register 31, the display synthesis processing device 32 in the display synthesis device 3 transmits display message of the private display memory 202 of the operation system 201 to the corresponding arithmetical locality in the monitor 4 through the display control device 33.

According to different locations, for example, if the current location of mouse 5 is in the operating window of operation system 101, the display synthesis processing device 32 connects the mouse to mouse connector 103 in computer 1. If the current location of mouse 5 is in the operating window of operation system 201, the display synthesis processing device 32 connects the mouse to mouse connector 203 in computer 2. Connection can also be made through the messages sent by the mouse to display synthesis processing device which transmit the messages. If the messages are transmittable, the connection is successful. If not, then there is no connection.

Difference between current embodiment and embodiment 2 is that embodiment 2 is scanned overlapping and the current embodiment is that the display synthesis processing device generates scanned messages and transmits to the monitor according to the scanned messages generated by the private display memory through the display control devices. The use of mouse is similar to that in embodiment 2.

The video memory device is used in both embodiment 2 and 3. Private video memory means that the video memory is only provided to the corresponding operation systems. It can be achieved by two physical separated video memory devices, meaning when the CPU is reading and writing on one of the video memory devices, the CPU cannot read and write on the other one. Alternatively, the video memory device can be used repeatedly by the method of backup recovery. In the present invention, display of two messages of two operation systems is necessary, and thus the only way is to use two different physical separated video memory devices.

However, the users sometimes want to use two or more operation systems and sometimes need only one operation system. Embodiment 4 provides a better way to solve the problem of unreasonable use and waste of video memory.

### Embodiment 4

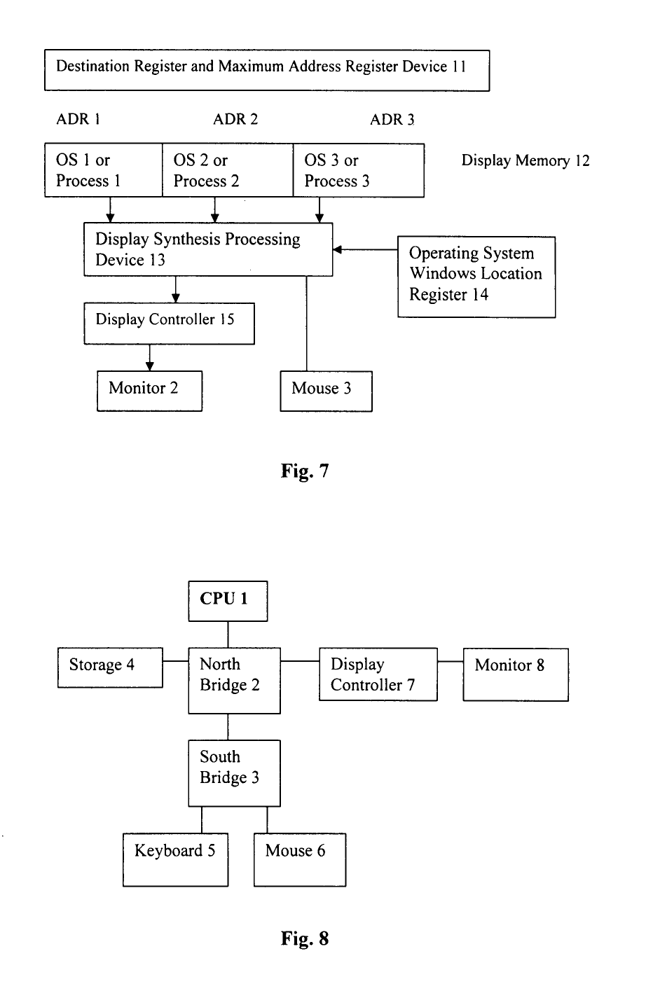

FIG. 7 is the schematic representation of the present invention based on embodiment 4. In this embodiment, destination register and the maximum address register 11 are connected with display memory 1, which is divided three areas all connected with the display synthesis processing device 13. The display synthesis 13 are connected with monitor 2 through monitor-controller, operation system window location register 31 and the mouse 5 are connected with the display synthesis processing device 13.

The display memory can be considered as address from 0 to MAX (maximum). A window can be formed through destination register and maximum address register 11, and the associated technology can be seen in some patent applications (referring to Chinese Patent Application ZL02113032.9) in which, however, the hard disk address is changed to display address instead. The configuration of display memory address used by every operation system is in destination register and maximum address register device 11. When the computer enters operation system 1 (or process 1), security switching process chooses corresponding display memory configuration (e.g. destination address is 0, maximum is 16 trillion, and the display memory is 64 trillion). 16 trillion display memory is considered and used by operation system 1. When the computer enters operation system 2 (or process 2), security switching process chooses corresponding display memory configuration (e.g. destination address is 16 trillion, maximum is 32 trillion), and 32 trillion display memory is considered and used by operation system 2.

According to display memory configuration of the operation system in destination register and maximum address register device 11 and the configuration of each operation system in an operation system windows location register 14, display synthesis device 13 outputs the display messages of operation system 1 (or process 1) and operation system 2 (or process 2) to corresponding locations in monitor 2 through a display control device 15.

According to the location of mouse 3 in the monitor, for example, if mouse 3 is currently located in the operating window of operation system 1, display synthesis processing device 13 connects the mouse to operation system 1. If mouse 5 is currently located in the operating window of operation system 2, display synthesis processing device 13 connects the mouse to operation system 2. The message of connection between mouse and operation system is transmitted through display synthesis processing device. If the messages are transmittable, the connection is successful. If not, then there is no connection.

The main point of this embodiment is that the display memory of the computer can be used flexibly based on the configuration required. In some special computer applications, security process is seldom used and produces less display messages like Intel LT technology, such that partition on the display memory is not necessary and combination of the output messages is not desired. The security process can only be shown in some relatively fixed location.

Security and convenience can be guaranteed according to above four embodiments. From the aspect of convenience, the mouse can be used for demonstrating different functions, such as setting size of the window, setting background operation system, and changing background operation system. A schematic representation of traditional computer structure is shown in FIG. 8 in which the mouse is connected to South Bridge of the computer such that all messages of the mouse are shown in current operation system. This is neither secure nor convenient for the users to switch between operation systems. It is also not easy to assure the user's motivation and work when they are operating the mouse.

### Embodiment 5

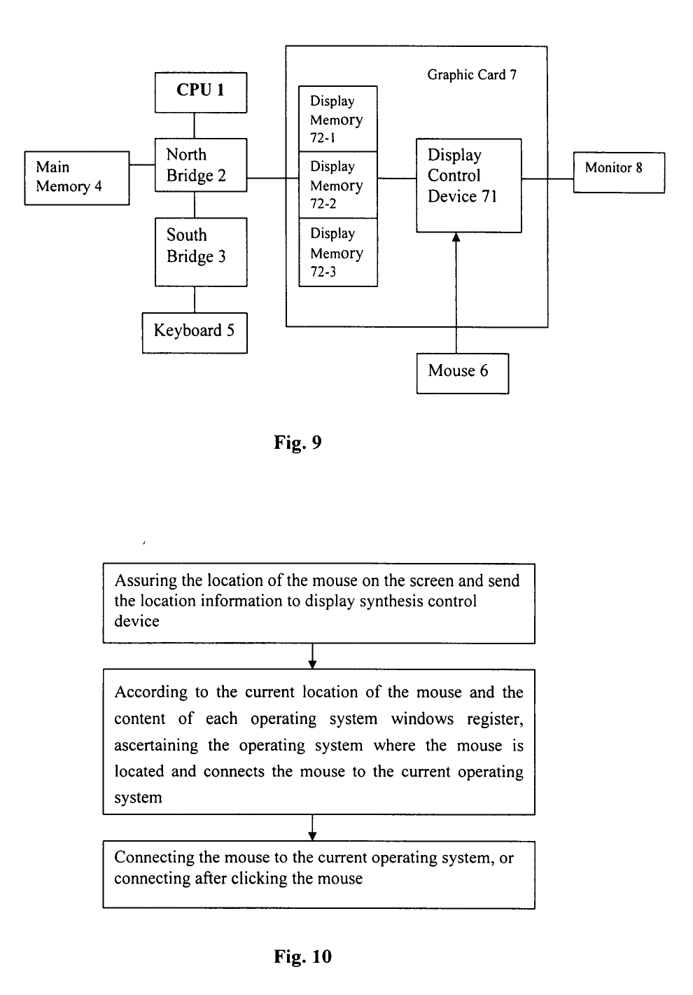

A schematic representation of embodiment 5 is shown in FIG. 9 in which the connections of CPU1, North Bridge 2, main memory 4, South Bridge 3 and keyboard 5 are the same as traditional computer structures. A graphic card 7 is connected to the North Bridge 2 and monitor 8. Mouse 6 is connected with a display controller 71 in graphic card 7 and this is different from traditional computer structures. Display memory, similar as embodiment 4, can be divided into three parts 72-1, 72-2 and 72-3 which are connected with display controller 71.

Similar to previous embodiments, the display controller 71 reads display messages of three operation systems (processes) from display memories 72-1, 72-2 and 72-3, and outputs to monitor 8 by combination and overlapping. According to the window mouse 6 belongs to on the screen, the display controller 71 determines mouse 6 to connect to one of the operation systems of 72-1, 72-2 and 72-3.

Obviously, the mouse is a screen locator. Other screen locators can be an electronic pen, a touch screen or other screen locating devices. In addition, if exchange of messages is necessary between the keyboard and a display controller 7, the keyboard can be connected to the display controller 7 which changes the way of connection in existing computer structures.

A window is the representation of the operation system on the screen. The user can use window overlapping technology in Microsoft Windows to show multiple operation systems based on his/her habits. In these windows, the mouse belongs to each window and a window represents a process. By locating and clicking, the mouse assures that the messages are sent to certain processes. Obviously, there is no physical separation between each process. The following display method is shown by adopting Microsoft Windows' technology in display synthesis of multiple operation systems.

### Embodiment 6

FIG. 10 is the schematic representation of embodiment 6 in the present invention. First, the display synthesis device assures the location of the mouse on the screen. Second, based on the current location of the mouse and the content of each operation system window register, the display synthesis device ascertains the operation system. Third, the mouse is located and the current operation system is connected with the mouse.

In the third step, connection between the mouse and current operation system can be ascertained by clicking the mouse. Even after clicking the mouse, the mouse and current operation system is not connected unless the user's identification is confirmed.

Furthermore, the confirmation method in the third step can be click at least once on the left key of the mouse in the window of the operation system. Meanwhile, the background operation system can be changed or unchanged by clicking the mouse.

Preferably, the layers of overlapped windows of operation systems can be changed by clicking the left key of the mouse once. While clicking twice, the corresponding operation system is changed to background operation system and the background operation system is changed to corresponding display window.

### Embodiment 7

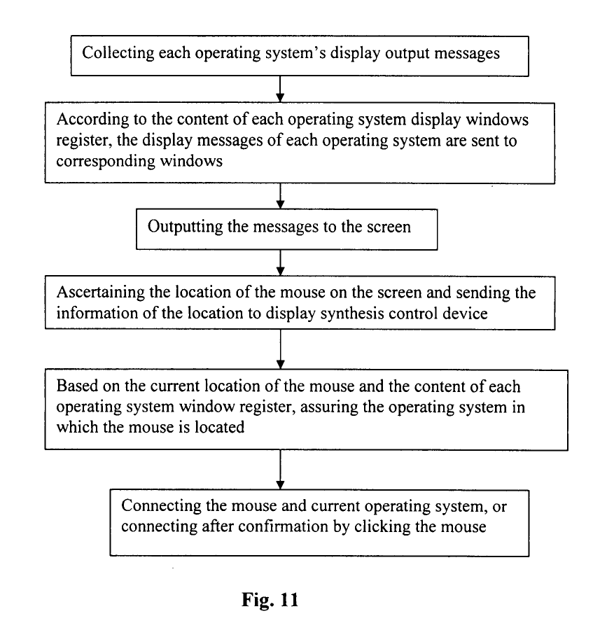

FIG. 11 is the schematic representation of embodiment 7 in the present invention in which comprises the steps of:

1. Collecting each operation system's display output messages.

2. According to the content of each operation system display windows register, the display messages of each operation system are sent to corresponding windows.

3. Outputting the messages to the screen.

4. Ascertaining the location of the mouse on the screen and sending the information of the location to display synthesis control device.

5. Based on the current location of the mouse and the content of each operation system window register, assuring the operation system in which the mouse is located.

6. Connecting the mouse and current operation system, or connecting after confirmation by clicking the mouse.

Furthermore, the confirmation method in step 6 can be click at least once on the left key of the mouse in the window of the operation system. Meanwhile, the background operation system can be changed or unchanged by clicking the mouse.

Preferably, the layers of overlapped windows of operation systems can be changed by clicking the left key of the mouse once. While clicking twice, the corresponding operation system is changed to background operation system and the background operation system is changed to corresponding display window.

Although the present invention illustrates the display synthesis method and device of two computers or two operation systems, it is obvious that this method and device can be applied to multiple computers or multiple operation systems in one computer. One skilled in the art will understand that the embodiment of the present invention as shown in the drawings and described above is exemplary only and not intended to be limiting.

What is claimed is:

1. A computer display synthesis device for operatively connecting two or more computer devices with a display screen, comprising:
a connecting device adapted for communicatively connecting display outputs of said computer devices each of which has an operating window;
a memory adapted for storing arithmetical localities of output signals of said computer devices;
an outputting device for synthetically outputting said operating windows to said display screen,
an input selection device; and
a display synthesis control device,
wherein said display synthesis control device receives said output signals from said computer devices through said connecting device and generates a plurality of display signals for said computer devices in responsive to said arithmetical localities thereof through said memory, wherein when said input selection device is activated to select one of said operating windows to be displayed on said display screen, said display synthesis control device is arranged for communicatively synthesizing said operating window with said corresponding computer device for operation.

2. The computer display synthesis device, as recited in claim 1, wherein said connecting device comprises means for operatively connecting to a display output memory of each of said computer device.

3. The computer display synthesis device, as in claim 1 or 2, wherein the input selection device comprises a screen locator arranged in such a manner that when said screen locator is located at one of said operating windows on said display screen, said display synthesis control device is arranged for operatively synthesizing said operating window with said corresponding computer device.

4. The computer display synthesis device, as recited in claim 3, wherein said screen locator comprises a device selected from the group consisting of a mouse, an electronic pen and a touch screen.

5. The computer display synthesis device, as in claim 1 or 2, wherein one of said operating windows is selectively set as a background window on said display screen.

6. The computer display synthesis device, as in claim 1 or 2, wherein said input selection device comprises a keyboard operatively actuated for selecting one of said operating windows to synthesize said operating window with said corresponding computer device.

7. The computer display synthesis device, as recited in claim 6, wherein said outputting device outputs said operating windows on said display screen in an overlapped layering manner such that said operating window being selected by said input selection device is displayed on said display screen on top of the rest of said operating windows.

8. The computer display synthesis device, as in claim 1 or 2, wherein said connecting device is operatively connected to said computer devices which are individual computers respectively to operatively control said computers.

9. The computer display synthesis device, as in claim 1 or 2, wherein said connecting device is operatively connected said computer devices which are individual operation systems respectively to operatively control said operation systems in one single computer.

10. A method of computer display synthesis, comprising the steps of:
(a) ascertaining a pointer of a computer display synthesis device being located at one of operating windows displayed on a display screen;
(b) ascertaining an operation system in responsive to a current location of said pointer at said corresponding operating window and a registry of each of said operation systems; and
(c) communicatively connecting said operating window to said corresponding operation system for operation.

11. The method as recited in claim 10 wherein, in the step (c), a connection is made between said operating window and said corresponding operation system by clicking a mouse when said pointer of said mouse is located at said corresponding operating window.

12. The method as recited in claim 10 wherein, in the step (c), a connection between said operating window and said corresponding operation system is confirmed by clicking at least one on a left key of a mouse when said pointer of said mouse is located at said corresponding operating window, wherein said mouse is adapted to selectively change or unchanged a background operation system simultaneously when said operation system is currently switched.

13. The method as recited in claim 10 wherein, in the step (c), said operating windows are outputted on said display screen in an overlapped layering manner, wherein said operating window being selected by said pointer of a mouse is displayed on said display screen on top of the rest of said operating windows by one click of a left key of said mouse, wherein locations of said operating window being currently operated and a background operating window are exchanged by double-clicking said left key of said mouse.

14. The method as recited in claim 10, before the step (a), further comprising the steps of:
collecting output signals of said operation systems;
synthesizing said output signals to generate a plurality of display signals for said operating windows in responsive to said registries of said operation systems; and
outputting said display signals to said display screen.
